(19) United States
(12) Patent Application Publication
(10) Pub. No.: US 2004/0075866 A1
(43) Pub. Date: Apr. 22, 2004

(54) Poster preparation system and method

(76) Inventors: Arne D. Thormodsen, Corvallis, OR (US); Diane R. Hammerstad, Corvallis, OR (US); Kenneth H. Bronstein, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/273,877

(22) Filed: Oct. 18, 2002

(51) Int. Cl. G06F 15/00; G06K 15/02; G06F 13/00; G06F 3/12

(52) U.S. Cl. 358/1.18; 358/1.15

(57) ABSTRACT

A poster generation system and method includes interaction between a publishing server and a client, for example including interaction via a global computer network, to generate a poster. The client downloads one or more poster templates from the publication server. A poster template is then populated on the client, associating image files with corresponding copy holes in the template. The images may be manipulated relative to the copy holes, for example being translated, re-scaled, or rotated. Image data is then uploaded to the publishing server for generation of a preview image and a printable poster image.

### RELATED APPLICATION

This application is related to concurrently-filed, commonly-assigned U.S. patent application Ser. No. ______ (Docket No. 10013860-1), entitled “Poster Preparation System and Method”, which is hereby incorporated by reference in its entirety.

### BACKGROUND ART

Printing services have long provided a means of enlarging photographs and printing them as posters. With the advent of the Internet, conventional enlargement of photographs and printing of posters has become an electronic business through the use of a global collection of computer networks and gateways that allow communication between computers via high-speed data communication lines between major nodes or host computers. Web sites for electronic poster-producing businesses may be accessed on the World Wide Web (“the Web”), via conventional software and hardware such as a Web browser, in order to obtain information regarding sizes and prices of posters. Image files may then be submitted to the electronic poster producer via electronic mail or via computer-readable media sent by ordinary post.

It will be appreciated that prior electronic poster-producing processes such as those described above are limited in their flexibility and make only limited use of the potential of a global computer network such as the Internet.

### BRIEF DESCRIPTION OF THE DRAWINGS

The invention may be understood with reference to the following drawings, which are not necessarily to scale. Also, in the drawings, like reference numerals designate corresponding parts throughout the several views.

FIG. 1 is a block diagram of a poster generation system, according to an embodiment of the present invention;

FIG. 2 is a high-level flowchart of some of the functionality of the poster generation system of FIG. 1;

FIG. 3 is a high-level flowchart of some of the functionality performed in a client of the poster generation system of FIG. 1;

FIG. 4 is a flowchart of somewhat more detailed functionality of the template population of FIG. 3;

FIG. 5 is a screen shot representation of a graphical user interface for populating a template, displayed using the poster generation system of FIG. 1;

FIG. 6 is a screen shot representation of a graphical user interface for selecting a preview image, displayed using the poster generation system of FIG. 1; and

FIG. 7 is a high-level flowchart of some of the functionality of the publishing server of the poster generation system of FIG. 1.

### DETAILED DESCRIPTION

A poster generation system and method includes interaction between a publishing server and a client, for example including interaction via a global computer network, to generate a poster. The term “poster”, as used herein, is broadly defined as a document larger in size than a standard-sized piece of media (letter, legal, or A4). The client downloads one or more poster templates from the publication server. The term “template”, as used herein, is defined as a pre-designed document format that contains preselected text and/or graphics, as well as containing one or more copy holes to receive user-selected images, graphics, and/or text. The template may include various poster layouts to be populated by a user of the client through selection of graphical elements and by addition of image files selected by the user of the client. The selection process may be performed in a what-you-see-is-what-you-get (WYSIWYG) graphical user interface. The interface may display an updated view of the poster layout as the layout is populated. This aids the user in obtaining an acceptable arrangement of images within the layout. The interface may also allow the user to manipulate the images populating the template, for example re-scaling the image and translating the image to allow a magnified portion of the image to appear in the copy hole of the template.

After the population process is completed, information regarding the poster may be uploaded by the client to the publishing server. The information includes image data which may include electronic versions of image files and/or locators where the image files may be obtained, either on the publishing server or on other computers coupled to the publishing server via a network. The publishing server then retrieves the image files, if necessary and may perform error checking on the image files, for example checking to see that the image files are readable and in a format that can be utilized by the publishing server and that the image files meet a minimum resolution threshold. A preview image may then be created and downloaded to the client. The preview image may be all or of a part of the poster and may be printed by the user of the client in order to check a sample showing the actual resolution of the poster to determine if the resolution is acceptable to the user of the client.

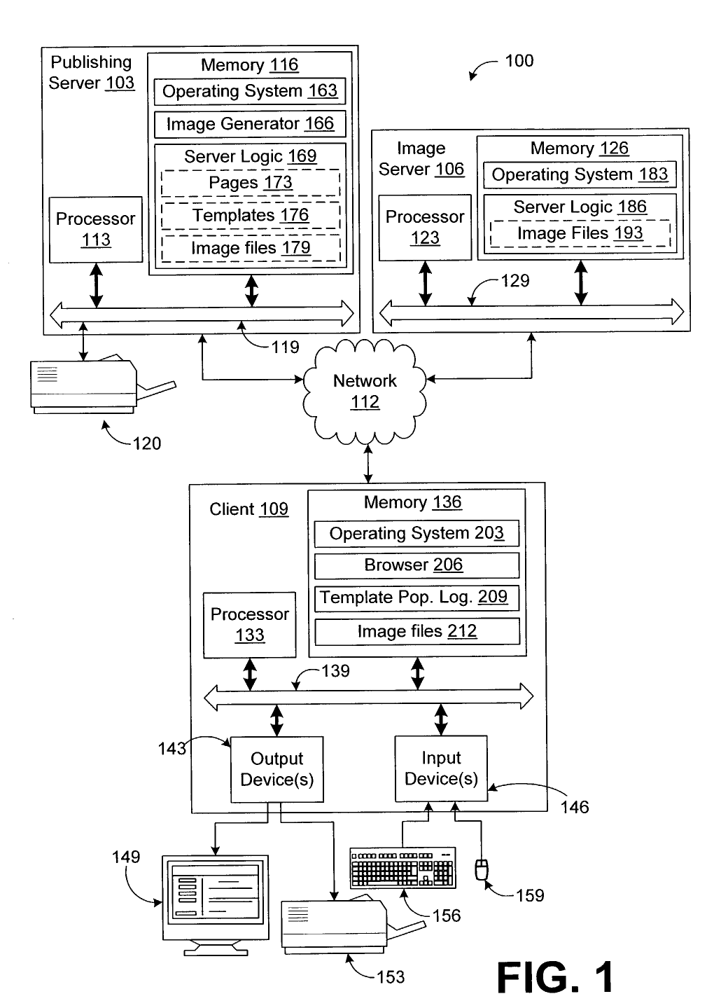

Referring initially to FIG. 1, a poster generation system 100 is shown. The poster generation system 100 includes a publishing server 103, an image server 106, and a client 109, all of which are coupled to a network 112. The publishing server 103 may include, for example, a computer system or other apparatus with similar capability. In particular, the publishing server 103 includes a processor circuit with a processor 113 and a memory 116, both of which are coupled to a local interface 119. The local interface 119 may include, for example, a data bus with an accompanying control/address bus, as is generally known by those with ordinary skill in the art.

Various peripheral devices may be coupled to the local interface 119. In particular, peripheral devices may include, for example, a keyboard, keypad, touch pad, touch screen, microphone, scanner, mouse, joystick, or one or more push buttons, etc. The peripheral devices may also include display devices, indicator lights, speakers, printers, etc. Specific display devices may be, for example, cathode ray tubes (CRTs), liquid crystal display screens, gas plasma-based flat panel displays, or other types of display devices, etc. For example, the publishing server 103 may have a printer 120 attached thereto via the local interface 119.

Similarly, the image server 106 may include, for example, a computer system or other system with similar capability. In particular, the image server 106 includes a processor circuit with a processor 123 and a memory 126, both of which are coupled to a local interface 129. The local interface 129 may be, for example, a data bus with an accompanying control/address bus, as is generally known by those with ordinary skill in the art.

The client 109 may also include a computer system or other system with similar capability. The client 109 includes a processor circuit with a processor 133 and a memory 136, both of which are coupled to a local interface 139. The local interface 139 may be a data bus with an accompanying control/address bus. The client 109 also includes various output interfaces 143 and input interfaces (shown as devices in FIG. 1) 146, through which the client 109 may be connected to various peripheral devices. Such peripheral devices may include a display device 149, a printer 153, a keyboard 156, and a mouse 159. Other peripheral devices that may be employed by the client 109 to receive various user input and/or to provide user output, include those listed above with regard to the publishing server 103.

The memories 116, 126, and 136 are defined herein as both volatile and non-volatile memory and data storage components. Volatile components are those that do not retain data values upon loss of power. Non-volatile components are those that retain data upon a loss of power. Thus, the memories 116, 126, and 136 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory devices.

In addition, each of the processors 113, 123, and 133 may represent multiple processors and each of the memories 116, 126, and 136 may represent multiple memories that operate in parallel. In such a case, the local interfaces 119, 129, and 139 may be appropriate networks that facilitate communication between any of the multiple processors, between any processor and any of the memories, or between any two of the memories etc. The processors 113, 123, and 133 may be electrical or optical in nature.

The network 112 includes, for example, the Internet, intranets, wide area networks (WANs), local area networks (LANs), wireless networks, or other suitable networks, etc., or any combination of two or more such networks. The publishing server 103, the image server 106, and the client 109 may be coupled to the network 112 in any number of ways known by those with ordinary skill in the art so as to facilitate data communication to and from the network 112. In this respect, the publishing server 103, the image server 106, and the client 109 may be linked to the network 112 through various devices such as, for example, network cards, modems, or other such communications devices, etc.

The publishing server 103 includes various software components that are stored on the memory 116 and are executable by the processor 113. These components include an operating system 163, an image generator 166, and server logic 169. The server logic 169 may include a network server, and may include one or more pages 173. In addition, the server logic 169 includes one or more templates 176 and may include image files 179.

The image server 106 also includes various software components, which are stored on the memory 126 and are executable by the processor 123. These components include an operating system 183, as well as server logic 186 that may include image files 193. The image files 193 may be stored in any of a variety of well-known formats or forms. For example, the image files 193 may be stored in a database so as to be easily identified and retrieved when needed. It will be appreciated that the functions of the publishing server 103 and the image server 106 may be combined in a single server or may be different servers on a single computer.

The client 109 also includes software components that are stored on the memory 136 and are executable by the processor 133. These components include an operating system 203 and a browser 206. By manipulating the browser 206, the pages 173 may be downloaded from the publishing server 103, having been transmitted by the server logic 169, which is stored on the memory 116 of the publishing server 103. Thus, the browser 206 and the server logic 169 may operate, for example, according to the dictates of the Hypertext Transfer Protocol (HTTP) employed on the World Wide Web or other suitable protocol. In this sense, the pages 173 may be created using a markup language, such as hypertext markup language (HTML), as is generally known by those with ordinary skill in the art. Alternatively, other programming languages or formats may be employed to create the pages 173, including extensible markup language (XML) or another mark-up language, JAVA, Active Server Page Scripting (ASP), JAVASCRIPT, C++, or other suitable computer languages and/or formats. It will also be appreciated that that the pages 173 may include other types of pages and/or data files.

The memory 136 also includes template population logic 209 and may include image files 212. The template population logic 209 allows a user of the client 109 to populate the templates 176 which are downloaded from the publishing server 103. One of the templates 176, or a representation thereof, may be displayed, using a graphical user interface, on the display 149 that is coupled to the client 109. The user of the client 109 may then utilize input devices such as the keyboard 156 and the mouse 159 to indicate image files that are to be integrated into corresponding copy holes or spaces in the templates 176. The image files may be the image files 179 located on the publishing server 103, the image files 193 located on the image server 106, and/or the image files 212 located on the client 109.

Once the user of the client 109 has populated the template 176 to achieve a satisfactory layout for the poster, image data is uploaded from the client 109 to the publishing server 103, for further processing into a printable preview image and an image for the poster. The image data may be the image files themselves, locators corresponding to a location from which the image files may be retrieved, or a combination of the two. The template population logic 209 may be a separate stand-alone program, which may be downloaded from the publishing server 103 via one of the pages 173. Alternatively, the template population logic 209 may be an applet within one or more of the pages 173.

The operating systems 163, 183, and 203 are executed to control the allocation and usage of hardware resources, such as the memory, processing time and peripheral devices, in the publishing server 103, the image server 106, and the client 109, respectively. In this manner, the operating systems 163, 183, and 203 serve as the foundation on which applications depend as is generally known by those with ordinary skill in the art.

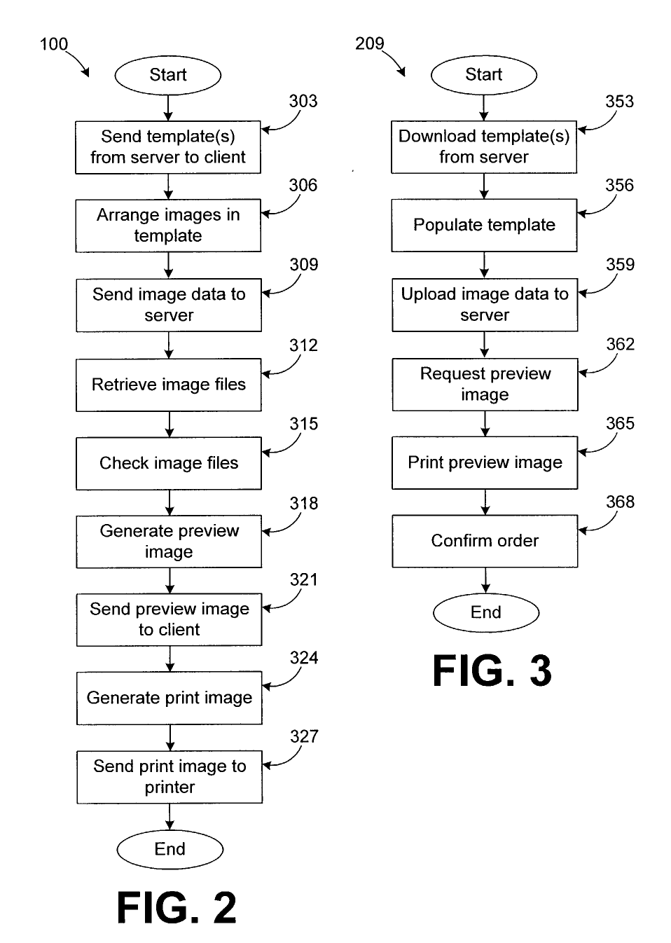

With reference now to FIG. 2, a high-level flowchart is shown, outlining the general functionality (logical function) of the poster preparation system 100 (FIG. 1). Alternatively, the flowchart of FIG. 2 may represent method steps taken in operation of the poster preparation system 100, including steps taken in both the image generator 166 of the publishing server 103 and the template population logic 209 of the client 109. In block 303, a template or templates 176 are sent from the publishing server 103 to the client 109. The templates 176 may be part of one or more of the pages 173 and may be sent via the network 112. Alternatively, the templates 176 may be sent via the network 112 in another manner, for example being sent in an electronic mail message. As another alternative, the templates 176 may be sent to the client 109 by other means, such as being loaded from a computer-readable medium, such as a floppy disk or CD-ROM.

In block 306, the user of the client 109 arranges images in the template 176. As discussed earlier, a WYSIWYG interface may be displayed on the display 149 that is coupled to the client 109. An input device such as the keyboard 156 and/or the mouse 159 may be used to choose or otherwise indicate image files to be used to populate various copy holes or openings in the template 176. As described in further detail below, the block 306 may also allow manipulation of images within the template 176. The manipulation may include translation, re-scaling, and/or rotation of the images relative to the copy holes.

Following population of the template 176, image data is sent from the client 109 to the server 103 in block 309. As discussed earlier, the image data may be one or more of the image files 212 which are stored on the memory 136 of the client 109. Alternatively, the image data may be locators, for example uniform resource locators (URLs), corresponding to image files at other locations, for example the image files 179 on the memory 116 of the publishing server 103, and/or the image files 193 on the memory 126 of the image server 106. The image data may be part of a populated template, that is, the template 176 with image data included therewith or incorporated therein. The populated template may be transmitted as a populated template markup language file.

If necessary, in block 312 the publishing server 103 retrieves the image files corresponding to the locators and makes the image files available in the memory 116.

In block 315, the image files for populating the template 176 are checked. The checking may involve checking the format of the image files to determine if they are compatible with the image generator 166. Alternatively or in addition, the checking in block 315 may include checking the resolution of the image in the image files, for example checking to see that the resolution meets or exceeds a predetermined minimum resolution threshold. As another alternative, the checking in block 315 may include checking to determine if the images correspond in size and/or shape to the corresponding copy holes in the template 176. The minimum resolution threshold may be selected to avoid graininess in the image of the poster. The minimum resolution threshold may be set in light of possible resealing of the images by the user. As an example, the minimum resolution threshold may be 150 dots per inch (dpi), although it will be appreciated that other minimum resolution thresholds may be employed. The predetermined minimum resolution threshold may be a set constant value or may be based on the amount of magnification (rescaling) to be used in integrating the image into the template 176 to generate the poster. Thus, the checking may avoid poor quality poster images that may result from excessive magnification of images with insufficient resolution.

As another alternative, the degree of image compression is checked in block 315. Image compression may involve loss of data, such that an enlargement of the image may introduce various image defects, such as moiré effects, thereby rendering the image quality unacceptable. Thus, the checking in block 318 may include warning the user if the degree of image compression is such as to potentially introduce image defects. The user may then use an image preview print to determine if poster image quality meets expectations.

Thereafter, in block 318, a preview image is generated by the image generator 166. The preview image may be generated upon receipt of a preview image request from the client 109, for example via the network 112. The preview image may be an image of a selected part of the poster corresponding to the populated template. The preview image may be an image at substantially the same magnification as the poster to be generated. The portion of the poster to be included in the preview image may be indicated by interaction of the client 109 and a corresponding page 173. For example, as explained in greater detail below, the mouse 159 or another input device may be used to move a wire frame over a representation of the template 176 which appears on the display 149, allowing the user of the client 109 to select a part of the ultimate poster for printing as a test image.

The test image may be generated in the publishing server 103 in block 318, and may be sent to the client 109 via the network 112 in block 321. The test image may be sent, for example, as part of a page 173. It will be appreciated that alternatively the test image may be sent by the network 112 in another type of file, for example, as part of an electronic mail message. The test image may be printed out using the printer 153 that is coupled to the client 109. By printing the test image, the user of the client 109 may be able to make a determination regarding the acceptability of the resolution of the image files when they are enlarged to fit into the template 176. As noted above, often an image which looks fine on a small screen will be unacceptably grainy when magnified for use on a poster. Allowing the printing of a test image enables such a problem to be detected and rectified without the need for the cost and delay involved in fully printing an ultimately unacceptable poster. Moreover, allowing the user of the client 109 to select the portion of the poster for which the printable test image is generated enables the user to focus on one or more specific areas that are thought to be potential problem regions in the populated template poster design. If a problem is found in the printing of the test image, it will be appreciated that such problem may be rectified in any of a number of ways. For example, other images with higher resolution may be substituted. As another example, a different size may be selected for the final poster. Yet another example would be use of a different of the templates 176, for example utilizing a template with smaller copy holes for insertion of images.

Following the generation of the printable preview image, in block 324, a print image is generated. The print image is generated by the image generator 166 using the same information that is used to generate the printable preview image. It will be appreciated that the print image may be generated at the same time as the printable preview image. Alternatively, the image generator 166 may be configured to generate the print image only after an indication by the user of the client 109, that the preview image is acceptable. The print image may be embodied in a printer control language file or in a format designed to accurately describe page content, such as PostScript or PDF, or other commonly used page description formats.

Finally, in block 327, the print image is sent to a printer, such as the printer 120 (FIG. 1), for printing of the final poster. It will be appreciated that the printer for printing the final poster may be directly coupled to the publishing server 103, as is illustrated in FIG. 1. Alternatively, the printer for printing the poster may be in another location from the publishing server 103, for example being coupled to the publishing server 103 via the network 112. As a further alternative, the printer may be a non-networked remote printer, with data regarding the print image being sent to the non-networked remote printer by any of a variety of suitable means.

Turning now to FIG. 3, a flowchart is shown of the general functionality (logical functions) of the template population logic 209 (FIG. 1) of the client 109 (FIG. 1). Alternatively, the flowchart of FIG. 3 may represent method steps taken during its execution of the template population logic 209. The flowchart shown in FIG. 3 is directed to operations or functions of the system 100 which occur in the client 109.

In block 353, the template or templates 176 (FIG. 1) are downloaded to the client 109 from the publishing server 103 (FIG. 1).

Then, in block 356, the template 176 is populated, with image files being assigned to copy holes or places in the template 176 and with perhaps selections being made regarding layout and content of certain graphic elements of the template 176. As noted above, the population of the template 176 may be accomplished in a WYSIWYG interface displayed on the display 149 that is coupled to the client 109. As noted above, the interface may also allow manipulation of images within the template 176. The manipulation may include translation, re-scaling, and/or rotation of the images relative to the copy holes. An example of such an interface is described in greater detail below.

In block 359, image data is uploaded from the client 109 to the publishing server 103 via the network 112. The image data may be part of a populated template, that is, a template such as the template 176, coupled with image data. As noted above, the image data may be image files or alternatively, may be image locators that correspond to image files that are to be placed in the template 176. An image locator may be a URL or other path, such as a file path or may be a file name or other identifier of a location for retrieving an image file. Thus, a locator that corresponds to an image file and allows retrieval of the image file from a database or a file structure can be used. The image data may be uploaded to the publishing server 103 as part of a markup language file.

Following uploading of the image data, in block 362, the user of the client 109 may request a preview image. As described in greater detail below, the preview image may be selected in response to a page 173 downloaded from the publishing server 103 and displayed on the display 149, using the browser 206. After the preview image is generated in the publishing server 103 and downloaded to the client 109, in block 365, the preview image may be displayed on the display 149 that is coupled to the client 109 and/or may be printed on the printer 153 coupled to the client 109. The user may then review the preview image to determine if the preview image is acceptable.

The order of the poster may then be confirmed in block 368. The confirmation in block 368 may be accomplished in response to a prompt, for example a prompt from a page 173. Alternatively, the confirmation may be made from the client 109 to the publishing server 103, through the network 112, by other suitable well-known devices.

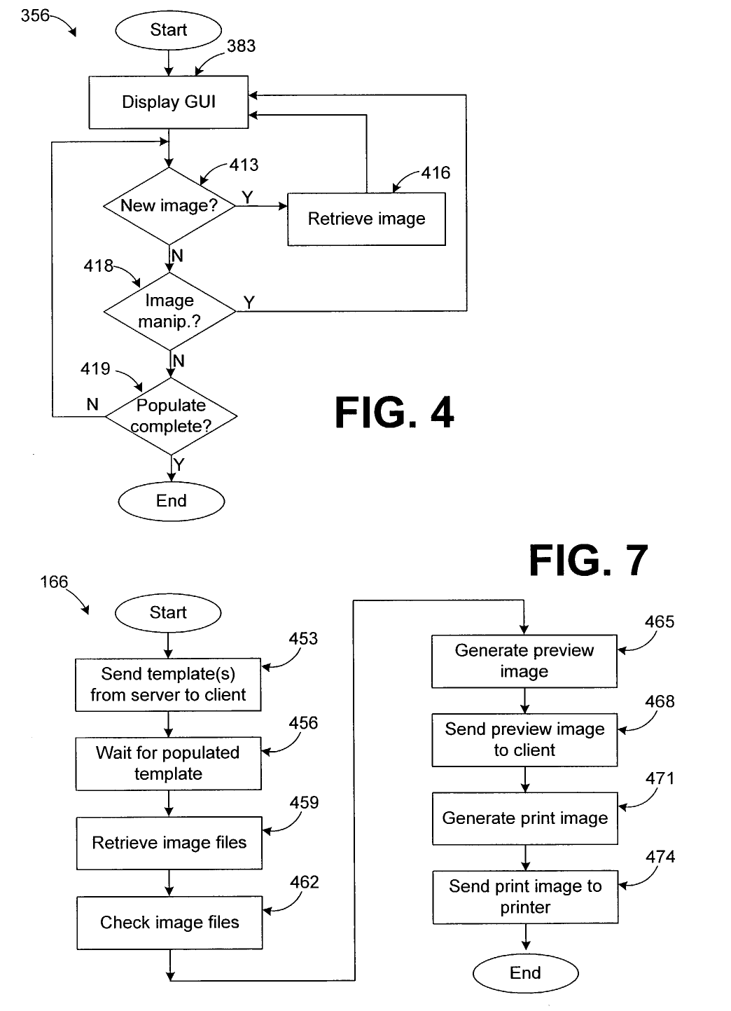

FIG. 4 shows a flowchart of a more detailed view of an example of the functionality (logical function) involved in the template population of block 356 (FIG. 3) of the template population logic 209 (FIG. 1). Alternatively, the flowchart of FIG. 4 may represent method steps taken during the block 356.

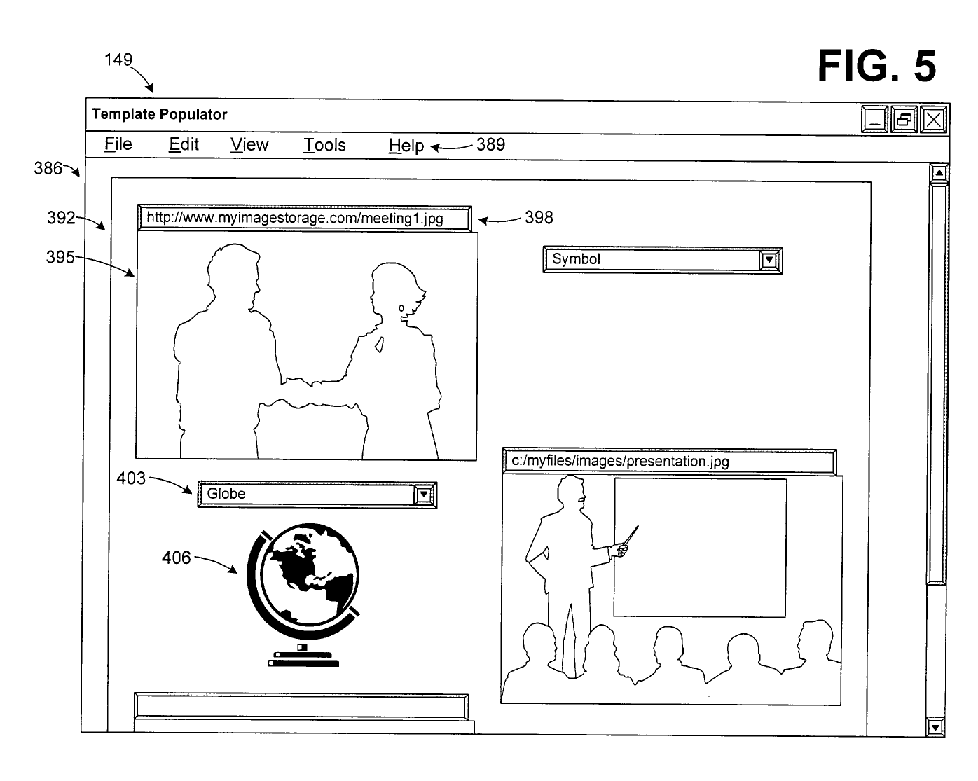

In block 383, a graphical user interface (GUI) is displayed on the display 149 (FIG. 1) that is coupled to the client 109 (FIG. 1). An example of such a graphical user interface is the GUI 386 shown in FIG. 5. The GUI 386 includes a menu bar 389 and an interactive template representation 392, which is a representation of the template 176 to be populated. The template representation 392 includes one or more spaces or copy holes to be populated with images, an example being the space or copy hole 395. Corresponding to each of the copy holes or spaces is a field such as the field 398. The field 398 may be configured to allow the user of the client 109 to enter text regarding the location of the image file to be placed in the corresponding copy hole 395. The text may be text such as that of any of the locators described earlier. Thus, the text may be a path corresponding to the location of an image file 212 (FIG. 1) on the client 109. Alternatively, the text may be a URL or other locator corresponding to a remotely-located image file, for example, the image files 179 (FIG. 1) on the publishing server 103 or the image files 193 (FIG. 1) on the image server 106 (FIG. 1). It will be appreciated that a mouse or other pointing device may be used to actuate a text-entering function for the field 398. However, many other suitable methods of data entry and/or file selection may be utilized. For example, keyboard commands may be used to navigate within the template representation 392 in order to place text in a suitable field such as the field 398. Further, many well-known alternatives exist to using fields. For example, pull-down menus, fields or dialog boxes may be utilized. As another example, the template population logic 209 may be configured to utilize a browsing function, for example, allowing the user of the client 109 to browse the image files 212 located on the client 109 and/or to browse the image files 179 or 193 located on remote servers. It will be appreciated that many other suitable methods of selecting and entering information regarding image files may be utilized. As another example, choices from pull-down menus on the menu bar 389 may be utilized in entering such information.

In addition, the GUI 386 may have pull-down menus, such as the pull-down menu 403, utilized for selecting graphic elements for corresponding spaces in the template representation 392. By making selections from the pull-down menu 403, a graphic element 406 may be selected form a list of choices.

It will be further appreciated that the GUI 386 may be suitably configured to allow population of the template by text and/or graphics, as opposed to population only by images. Text may be placed in a particular copy hole designated for text, such as a title block. Many suitable methods for selecting or entering text and/or graphics may be employed. Provisions may be made for overlaying text on images, with, for example, text in the foreground and images in the background. Further, it will be appreciated that the GUI 386 may be configured to allow multiple images to be placed in a single copy hole with the images perhaps partially overlaid one on another.

The template population logic 209 may be configured such that the template representation 392 is updated whenever new data is inserted (or deleted) via the fields, dialog boxes, pull-down menus, or other data entry devices. Alternatively, it will be appreciated that any of a variety of suitable devices may be provided for a user-initiated update of the template representation 392. For example, the template population logic 209 may include a button on the GUI 386, the actuation of which causes the view of the template representation 392 to be updated with the images and graphical elements indicated in the fields, dialog boxes and pull-down menus.

As indicated in FIG. 4, when new image information is entered into block 413, the images are retrieved in block 416. Then the updated GUI 386, with its updated template representation 392, is displayed in block 383. The retrieval of images in block 416 may include downloading of images from remote locations, such as the downloading of one or more of the image files 179 from the publishing server 103 and/or downloading of one or more of the image files 193 from the image server 106.

The GUI 386 is configured to allow manipulation of the images from image files 179 to change the appearance of the images within the template 176. Such manipulation may take the form of translating images, rotating images, changing magnification of images (re-scaling), and/or cropping images, for example. Manipulation may be accomplished, for example, by dragging a portion of the image in the copy hole 395 that corresponds to an image, thereby translating the image relative to the template 176 and specifically relative to the copy hole 395. An image that is larger than the copy hole 395 in the template may effectively be cropped thereby, with parts of the image hidden by the template 176, which may overlap the images of the image files. Alternatively, the user-selected manipulation may include cropping the image files to fit the copy holes or to otherwise prevent images from undesirably overlapping all or part of other items in the template.

As another example, the GUI 386 may be configured to allow magnification of the image by clicking on the portion of the GUI 386 that corresponds to the image. The magnification may result in the image being effectively cropped, in that parts of the image appearing outside the copy hole being hidden by the template 176.

It will be appreciated that manipulation of images may cause portions of two or more images to appear in the same copy hole. For example, an image may be magnified and/or translated such that a portion of that image overlaps another image in an adjacent copy hole. Questions as to which image to display in front for a given copy hole may be resolved, for example, by clicking on one of the multiple images in the same copy hole.

It will be appreciated that a variety of suitable commands, for example involving keyboard commands, mouse movements and/or clicks, and/or menu-driven commands, may be used to manipulate the images relative to the template 176, and specifically relative to the corresponding copy hole of the template 176. The manipulations may be recorded and stored in the client 109 and may be forwarded to the publishing server 103. The manipulations may be recorded in any number of suitable conventional ways, for example being numerically recorded as a series of numbers, corresponding, for example, to translations of an image in each of the directions of the page, magnifications of the image in each of multiple directions, and rotation of the image. The GUI 386 may be configured to transmit the image manipulation information, if any, from the client 109 to the publishing server 103 automatically when the template population interface is exited. Information regarding manipulation of the images may be in any of a variety of suitable forms, for example being represented in a six-component matrix, such as in the six-component matrix form that is used in PostScript language.

When image manipulation is detected in block 418, the GUI is updated in block 383, to reflect the changes due to the image manipulation. For example, an image may be translated, rotated, or re-scaled, relative to its copy hole. The user is thus provided with an updated view of the representation of the poster which is displayed in the GUI, allowing at least a rough view of the general layout of the poster with the present selections and manipulations.

In block 419, a check is made as to whether the population of the template is complete. If so, the template population 356 concludes, and the image data is uploaded from the client 109 to the publishing server 103 via the network 112. If not, the template population logic 209 awaits further entry of image information and/or graphical element information. The indication that the template population is complete may be a selection made by the user of the client 109, for example by actuating a suitable indicator, such as a button. It will be appreciated that other user-directed devices are available for indicating completion of the template population. Another example would be an entry from a pull-down menu in the menu bar 389.

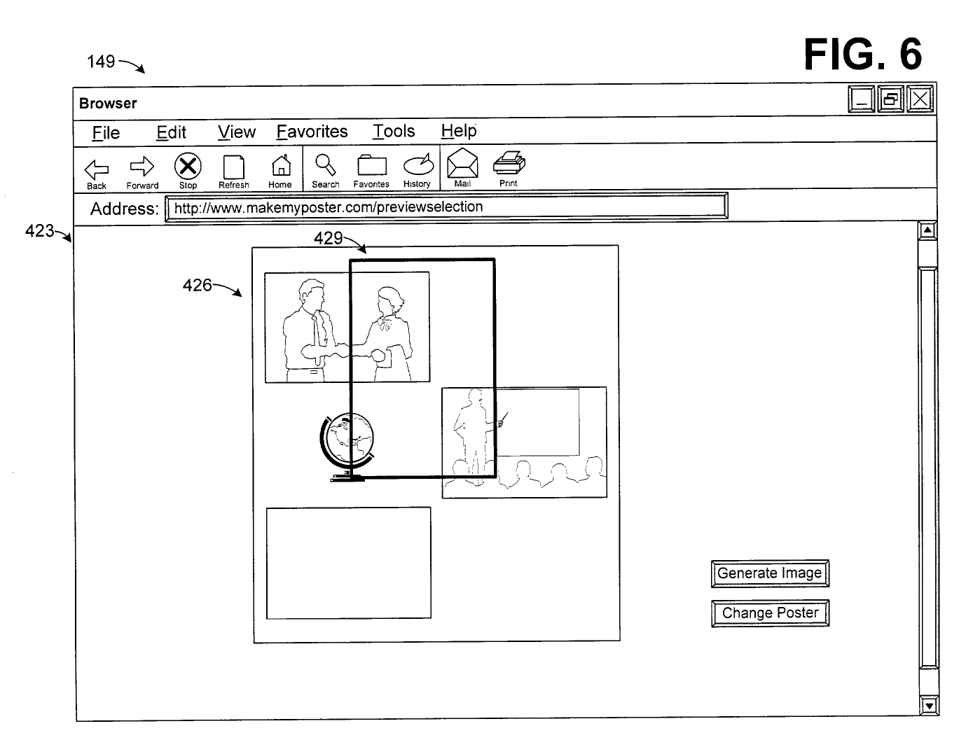

As noted above, the preview image may be selected in response to a page 173 downloaded from the publishing server 103 and displayed on the display 149 for use with the browser 206. FIG. 6 shows an example of a graphical user interface (GUI) 423 for allowing the user of the client 109 to select a preview image. A poster representation 426 is displayed as part of the GUI 423. The poster representation 426 may be a representation of the unpopulated template 176, or may be a representation of the template 176, populated with images and/or graphics. The template 176 may be populated by the previously-selected image files included in or corresponding to the image data, to generate the poster representation 426. It will be appreciated that lower resolution versions of the images, such as thumbnail images, may be used to populate the template 176 for generation of the poster representation 426.

The GUI 423 is configured to allow the user of the client 109 to select all or part of the poster representation 426 for generation of one or more corresponding preview images. For example, the GUI 423 may be configured such that the user of the client 109 is able to position a wire frame 429 corresponding to a printed page of a preview image to a desired location within the poster representation 426. The pages 173 and/or the template population logic 209 may be configured to allow changes in the size and/or orientation of the wire frame.

In addition, the user of the client 109 may be able to request multiple preview images, for example, a set of images allowing preview printing of all of the poster in multiple pages. The request for the preview image may be uploaded from the client 109 to the publishing server 103 via the network 112 through any of a variety of suitable devices, for example, as a mark-up language text file, or as an electronic mail message.

Turning now to FIG. 7, a flowchart is shown of the general functionality (logic function) of the image generator 166 (FIG. 1) of the publication server 103 (FIG. 1). In block 453, one or more of the templates 176 are sent from the publishing server 103 to the client 109 (FIG. 1) via the network 112 (FIG. 1). In block 456, the image generator 166 waits for population of the template and the uploading of the image data, which as indicated earlier, may be included as part of a populated template. If necessary, the image files are retrieved in block 459. Then the image files are checked in block 462. The checking may include checking the format of the image files and/or checking the resolution of the image files. It will be appreciated that other types of checking may be performed on the image files, for example, comparing the aspect ratio of the image in the image files with the aspect ratio of the corresponding copy holes in the template 176 into which the image files are to be placed.

In block 465, the image generator 166 generates a preview image of all or a part of the poster to be generated. The preview image may be selected such that there is a substantially exact correspondence between the size of a piece of media upon which the preview image is to be printed and the corresponding portion of the poster. The preview image may be embodied in a preview image file, which may include a command for the printer 153 to print out the preview image at its highest resolution setting. In block 468, the preview image is sent to the client 109. By printing the preview image, the user can make a determination regarding the acceptability of the resolution of the image files when they are enlarged to fit into the template 176.

Upon a confirmation received from the client 109, the print image is generated in block 471. It will be appreciated that the print image may be assembled by the processor 113 of the publishing server 103, using well-known methods to combine the template 176 with the image files indicated by the image data uploaded from the client 109.

It will be appreciated that the system and process described above may be varied in a variety of well-known ways. For example, the image files utilized in populating the template representation 392 (FIG. 5) may be thumbnail images, that is, reduced-size versions of the corresponding actual images to be used in producing the printable preview image and the print image. Further, the system and method described above have been described in terms of generating a poster, which was broadly defined above as a document larger in size than a standard-sized piece of media (letter, legal, or A4). It will be appreciated that the system and method may be utilized in generating other sorts of documents.

Although the image generator 166 (FIG. 1) and the template population logic 209 (FIG. 1) are embodied in software or code executed by general purpose hardware as discussed above, as an alternative the image generator 166 and the template population logic 209 may be embodied in whole or in part in dedicated hardware or a combination of software/general purpose hardware and dedicated hardware. If embodied in dedicated hardware, the image generator 166 and the template population logic 209 may be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flowcharts of FIGS. 2-4 and 7 show the architecture, functionality, and operation of an implementation of the image generator 166 and the template population logic 209 (FIG. 1). If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIGS. 2-4 and 7 show a specific order of execution, it is understood that the order of execution may differ from that which is depicted. For example, the order of execution of two or more blocks may be scrambled relative to the order shown. Also, two or more blocks shown in succession in FIGS. 2-4 and 7 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention. Also, the flowcharts of FIGS. 2-4 and 7 are relatively self-explanatory and are understood by those with ordinary skill in the art to the extent that software and/or hardware can be created by one with ordinary skill in the art to carry out the various logical functions as described herein.

Also, where the image generator 166 and the template population logic 209 (FIG. 1) includes software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system.

In the context of the present invention, a “computer-readable medium” can be any medium that can contain, store, or maintain the image generator 166 and the template population logic 209 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of generating a poster using a computer system, comprising:
sending an unpopulated poster template to a client via a network coupled to the computer system and the client;
processing image data received from the client via the network to create a printable image of at least a part of the poster; and
sending the printable image to the client.

2. The method of claim 1, wherein the image data received from the client is part of a populated poster template, and wherein the processing includes processing the populated poster template.

3. The method of claim 1, wherein the image data includes at least one image file, and wherein the processing includes integrating at least part of the at least one image file into the printable image.

4. The method of claim 1, wherein the image data includes an image locator, and further comprising, prior to the processing, retrieving an image file corresponding to the image locator.

5. The method of claim 1, wherein the processing includes processing image manipulation information, including positioning and scaling images relative to copy holes of the template, based on the image manipulation information.

6. A method of generating a poster using a client computer system, comprising:
downloading a poster template from a server computer system to the client computer system;
populating the poster template, wherein the populating the poster template includes selecting an image file for placement in a corresponding copy hole of the template; and
following the populating, uploading image data corresponding to the image file, from the client computer system to the server computer system.

7. The method of claim 6,
wherein the populating the poster template includes manipulating an image corresponding to the image file, relative to the copy hole; and
wherein the uploading includes uploading information regarding the manipulating of the image.

8. The method of claim 7, wherein the manipulating the image includes re-scaling the image.

9. The method of claim 7, wherein the manipulating the image includes translating the image relative to the copy hole.

10. The method of claim 7, wherein the manipulating the image includes rotating the image relative to the copy hole.

11. A poster generation computer program embodied in a computer readable medium, comprising:
code that sends an unpopulated template from a computer system to a client via a network coupled to the computer system and the client;
code that processes image data received from the client to create a printable image of at least a part of the poster determines non-local links within the page; and
code that sends the printable image to the client.

12. The computer program of claim 11, wherein the image data received from the client is part of a populated template, and wherein the code that processes includes code that processes the populated template.

13. The computer program of claim 11, wherein the image data includes at least one image file, and wherein the code that processes includes code that integrates at least part of the at least one image file into the printable image.

14. The computer program of claim 11, wherein the image data includes an image locator, and further comprising codes that retrieves an image file corresponding to the image locator.

15. The computer program of claim 11, wherein the code that processes includes code that processes image manipulation information, including code that positions and code that scales images relative to copy holes of the template, based on the image manipulation information.

16. A poster generation computer program embodied in a computer readable medium, comprising:
code that downloads a poster template from a server computer system to a client computer system;
code that populates the poster template, including code configured to allow a user of the client computer system to select an image file for placement in a corresponding copy hole of the template; and
code that uploads image data corresponding to the image file, from the client computer system to the server computer system, following population of the poster template.

17. The computer program of claim 16,
wherein the code that populates includes code that manipulates an image corresponding to the image file, relative to the copy hole; and
wherein the code the uploads includes code that uploads information regarding manipulation of the image.

18. The computer program of claim 17, wherein the code that manipulates the image includes code that re-scales the image.

19. The computer program of claim 17, wherein the code that manipulates the image includes code that translates the image relative to the copy hole.

20. The computer program of claim 17, wherein the code that manipulates the image includes code that translates the image.

21. A poster generation computer system comprising:
a processor coupled to a local interface;
a memory coupled to a local interface; and
processing logic stored on the memory and executable by the processor including:
logic that sends an unpopulated poster template from the computer system to a client via a network coupled to the computer system and the client;
logic that processes image data received from the client to create a printable image of at least a part of the poster determines non-local links within the page; and
logic that sends the printable image to the client.

22. A poster generation computer system comprising:
means for downloading a poster template from a server computer system to a client computer system;
means for populating the poster template, wherein the populating the template includes selecting an image file for placement in a corresponding copy hole of the template; and
means for uploading image data corresponding to the image file, from the client computer system to the server computer system, following population of the poster template.

23. A poster generation computer system comprising:
means for sending an unpopulated poster template to a client via a network coupled to the computer system and the client;
means for processing image data received from the client via the network to create a printable image of at least a part of the poster; and
means for sending the printable image to the client.

24. A poster generation client computer system comprising:
a processor coupled to a local interface;
a memory coupled to a local interface; and
processing logic stored on the memory and executable by the processor including:
logic that downloads a poster template from a server computer system to the client computer system;
logic that populates the poster template, including logic that allows a user of the client computer system to select an image file for placement in a corresponding copy hole of the template; and
logic that uploads image data corresponding to the image file, from the client computer system to the server computer system, following population of the poster template.
